(19) United States
(12) Patent Application Publication
(10) Pub. No.: US 2015/0285409 A1
(43) Pub. Date: Oct. 8, 2015

(54) METHOD FOR ASSEMBLING A RIGID PIPE INTENDED TO BE PLACED IN A STRETCH OF WATER, AND ASSOCIATED INSTALLATION AND PIPE

(71) Applicant: TECHNIP FRANCE, Courbevoie (FR)

(72) Inventors: Philippe Espinasse, Bihorel (FR); François Gooris, Paris (FR); Jean François Patinet, Villefranche de Lonchat (FR); Sébastien Viale, Versailles (FR); Mathieu Vaudoisey, Volnay (FR)

(21) Appl. No.: 14/436,293

(22) PCT Filed: Oct. 16, 2013
(86) PCT No.: PCT/EP2013/071586

§ 371 Date: Apr. 16, 2015

(30) Foreign Application Priority Data
Oct. 22, 2012 (FR) 12 60025

(51) Int. Cl. F16L 9/00

(52) U.S. Cl. CPC F16L 9/00

(57) ABSTRACT

A method including the following steps: assembling sections of metal tube end-to-end so as to form an inner tube having a continuous passage for circulation of fluid; positioning a thermally insulating sleeve around each section of metal tube, the thermally insulating sleeve comprising at least one longitudinal groove; introducing a continuous functional line into at least two longitudinal grooves in at least two adjacent sections of tube; and filling in each longitudinal groove in order to cover the continuous functional line.

The present invention relates to a method for assembling a rigid pipe intended to be placed in a stretch of sea, river or lake water, the rigid pipe comprising a metal inner tube, and a non-metal external casing for thermal insulation intended to be placed in contact with the stretch of water, the method comprising the following steps:
assembling metal tube sections end-to-end in order to form an inner tube having a continuous passage for circulation of fluid.

Such an assembling method is intended to be applied for laying rigid pipes in a sea, river or lake water stretch, with view to transporting fluid through the stretch of water.

For example, the pipe is intended for conveying a hydrocarbon at the bottom of the stretch of water or as far as a surface installation, with view to its treatment and to its subsequent transport towards a location of use.

The method is advantageously applied on installations for laying S- or J-shaped rigid pipes.

In a known way, the hydrocarbons collected at the bottom of a stretch of water may include compounds able to solidify at a low temperature, such as hydrates. It is therefore necessary to thermally insulate the pipes for conveying hydrocarbons, notably at great depths, in order to maintain the hydrocarbons at a temperature above the solidification temperature and avoid the formation of plugs.

To do this, it is known how to use rigid pipes of the “pipe in pipe” or “PIP”. These pipes include a metal inner tube intended for conveying the fluid, a metal external tube intended to be placed in contact with the stretch of water and an intermediate annular space between the tubes, in which is positioned a material contributing to the insulation.

In order to ensure heating, the tubes are electrically insulated from each other, and an electric power source is connected to the inner tube on the one hand and to the outer tube on the other hand in order to form a current loop.

Such a heating system, for example described in U.S. 2005/054228, requires having a high electric power source and a pipe of significant weight.

In order to overcome this problem, it is also known how to place an electric heating line in the annular space between the tubes. The electric line is directly applied on the inner tube, which allows reduction in the thermal losses.

However, the method for assembling such a rigid pipe may be tedious to apply, since it requires introduction of the electric heating line at the same time as the inner tube into the outer tube. The weight of the pipe moreover remains significant.

An object of the invention is therefore to obtain a method for assembling a rigid pipe provided with efficient heating means, which is simple to apply and which allows selection of pipes with better suitable dimensions and weight.

For this purpose, the object of the invention is a method of the aforementioned type, characterized in that the method comprises the following steps:
positioning a thermal insulation sleeve around each metal tube section, the thermally insulating sleeve comprising at least one longitudinal groove;
introducing a continuous functional line into at least two longitudinal grooves of at least two adjacent tube sections;
filling in each longitudinal groove so as to cover the continuous functional line.

The method according to the invention may comprise one or more of the following features, taken individually or according to any technically possible combination:
the filling in of each longitudinal groove comprises the setting into place of a self-supporting part of a thermally insulating material in the longitudinal groove;
the filling in of each longitudinal groove comprises the filling of each longitudinal groove with a fluid material and the hardening of the fluid material in order to form a plug of a thermally insulating material;
each metal tube section includes an end portion protruding longitudinally beyond the thermally insulating sleeve, the step for forming the continuous outer casing comprising, after assembling two adjacent tube sections end-to-end, the formation of a thermal insulation connection covering the end portions, the insulating connection connecting the thermally insulating sleeves of two adjacent tube sections;
said or each longitudinal groove is pre-formed during the manufacturing of the thermally insulating sleeve;
it includes a step for making at least one longitudinal groove in the thermally insulating sleeve by removing material;
the introduction step includes flattening of the continuous functional line against a bottom of the longitudinal groove via a guiding assembly;
the introduction step includes the unwinding of a coil bearing the continuous line, in order to bring the continuous line into a longitudinal groove;
it includes a step for laying as an S or as a J, metal tube sections assembled in the stretch of water, after the step for forming the outer casing.

The object of the invention is also an installation for assembling a rigid pipe intended to be placed in a stretch of water, the rigid pipe comprising a metal inner tube, and a non-metal outer thermal insulation casing intended to be placed in contact with the stretch of water, the installation comprising:
a station for assembling metal tube sections end-to-end in order to form an inner tube having a continuous passage for circulation of fluid;
characterized in that the installation includes:
an assembly for providing a plurality of tube sections provided with a thermally insulating sleeve, the thermally insulating sleeve comprising at least one longitudinal groove substantially extending as far as the metal tube;
a station for introducing a continuous functional line in at least two longitudinal grooves of at least two adjacent tube sections;
a station for filling in each longitudinal groove in order to cover the continuous functional line.

The installation according to the invention may comprise one or more of the following features, taken individually or according to any technically possible combination:
it includes a floating structure bearing the assembling station, the providing assembly, the introduction station, and the filling-in station.

The object of the invention is also a rigid pipe intended to be placed in a stretch of water, comprising:
a metal inner tube, and
a non-metal outer thermal insulation casing intended to be placed in contact with the stretch of water, the inner tube comprising an end-to-end assembly of metal tube sections, the inner tube delimiting a continuous passage for circulation of fluid;
the outer casing continuously extending around assembled metal tube sections;
characterized in that the outer casing includes a thermally insulating sleeve positioned around each metal tube section, the thermally insulating sleeve comprising at least one longitudinal groove substantially extending as far as the inner tube;
the pipe including a continuous functional line introduced at least into two longitudinal grooves of at least two adjacent tube sections;
the outer casing comprising a plug obturating each longitudinal groove for covering the continuous functional line.

The pipe according to the invention may comprise one or more of the following features, taken individually or according to any technically possible combination:
the plug is formed from a fluid material having hardened in the longitudinal groove;
the plug is formed from a self-supporting part added in the longitudinal groove;
the continuous functional line is selected from an electric heating cable, a hydraulic heating line, an electric and/or optical and/or hydraulic cable.

The invention will be better understood upon reading the description as follows, only given as an example, and made with reference to the appended drawings, wherein:

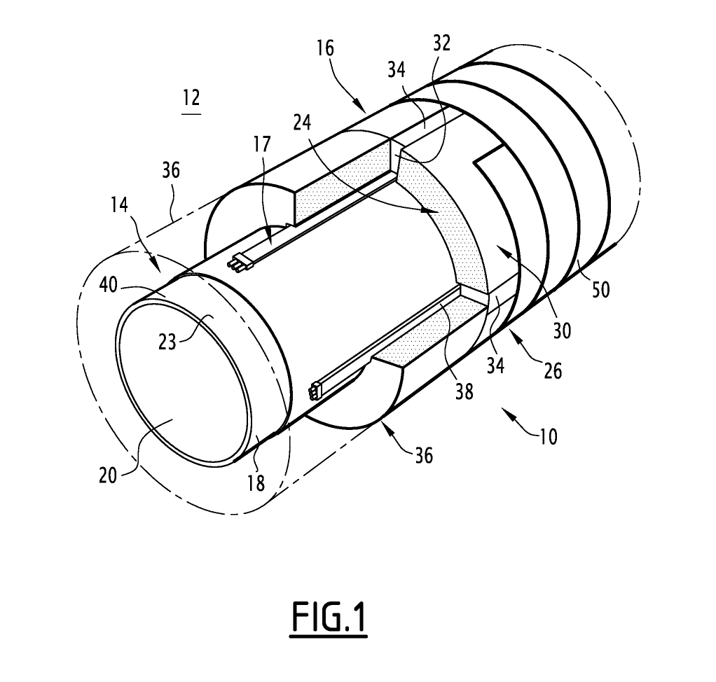

FIG. 1 is a partly exploded perspective view of a first rigid pipe according to the invention;

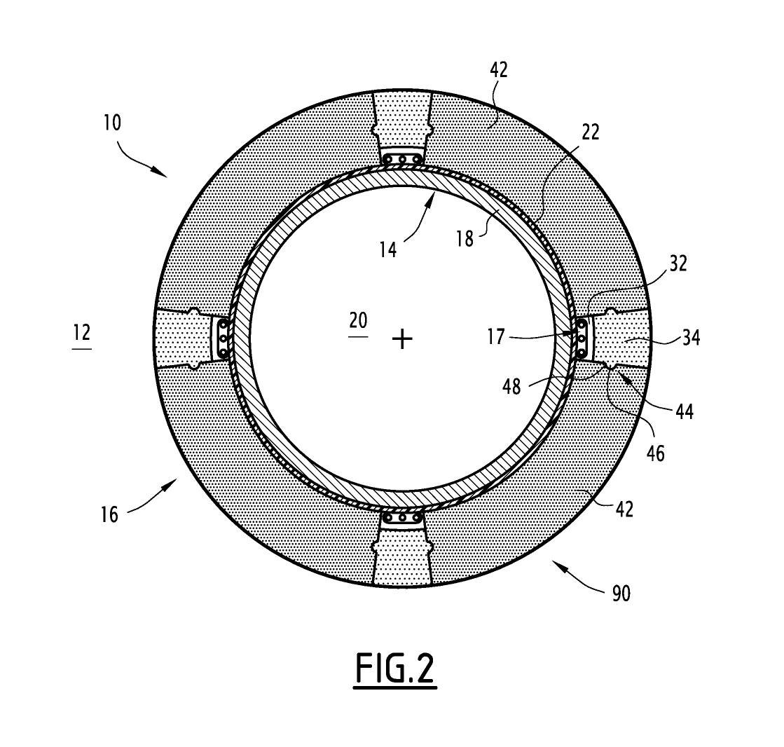

FIG. 2 is a sectional view along a transverse plane of the rigid pipe of FIG. 1;

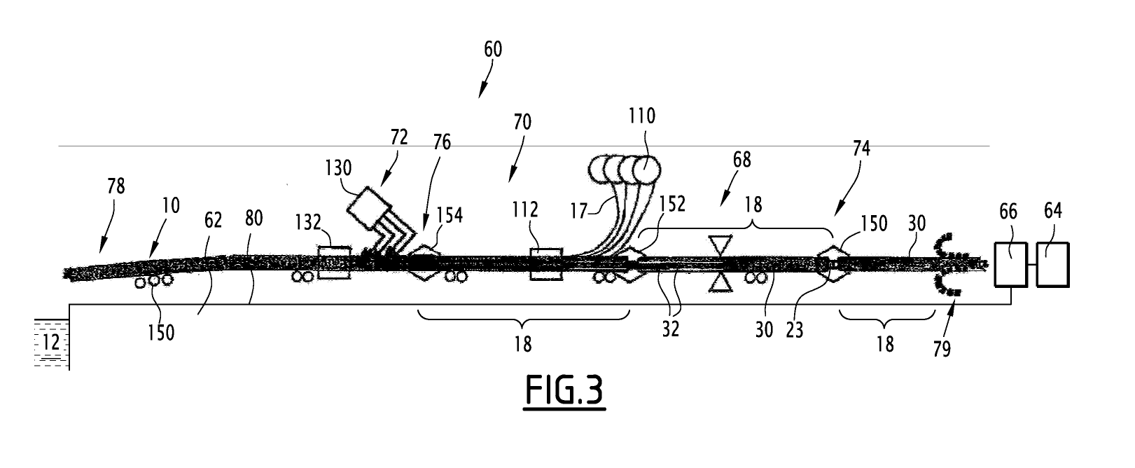

FIG. 3 is a schematic side view of a first installation for assembling the pipe of FIG. 1, for an S laying method;

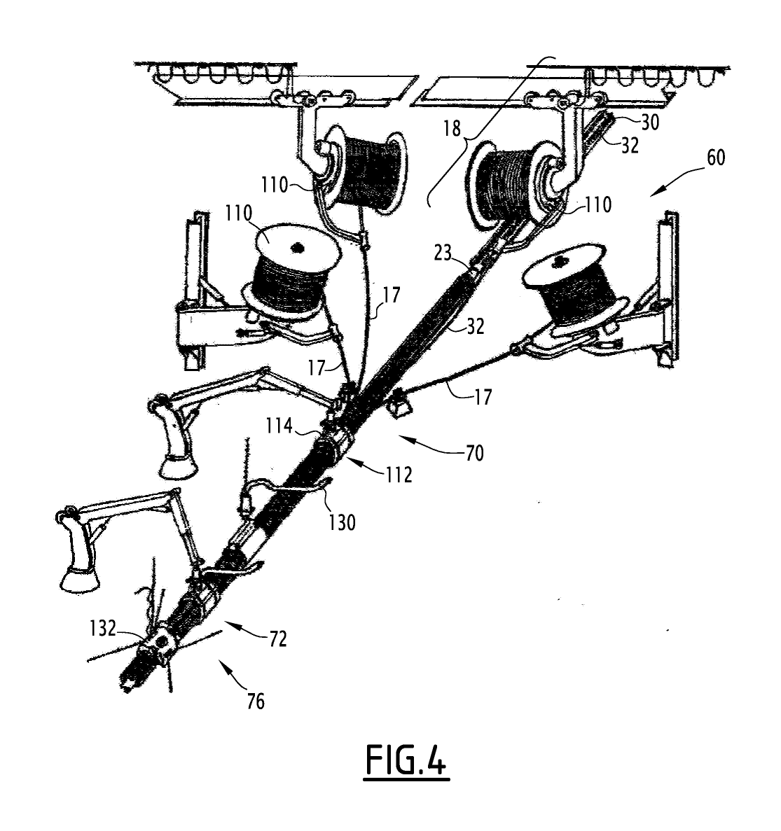

FIG. 4 is a partial perspective view of a portion of the installation of FIG. 3;

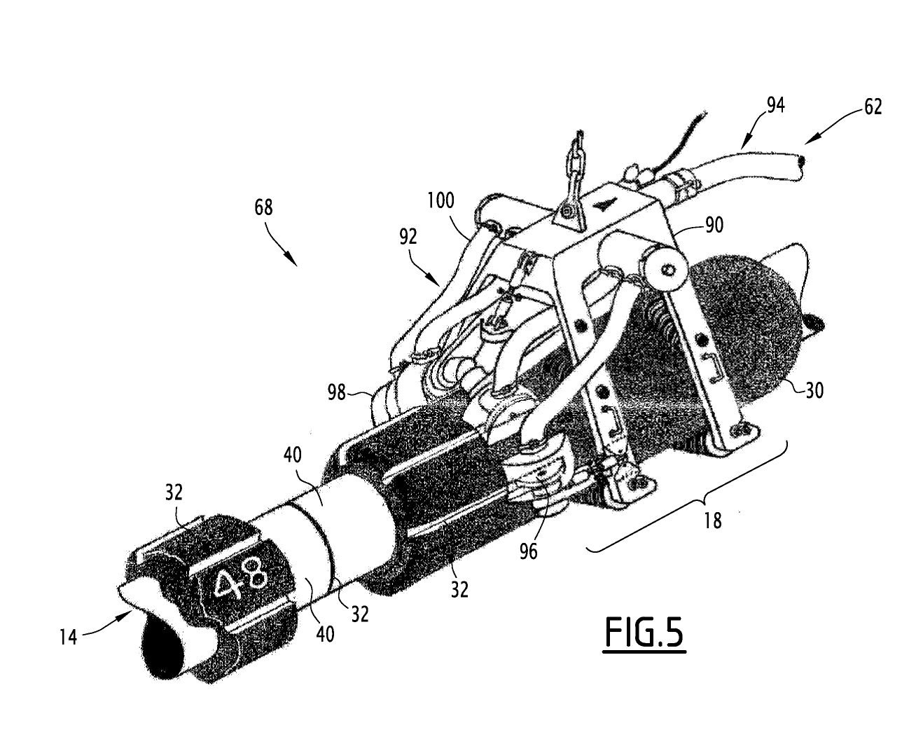

FIG. 5 is a perspective view of a detail of the installation of FIG. 4, representing a cutting assembly for forming longitudinal grooves in a thermally insulating sleeve of the rigid pipe;

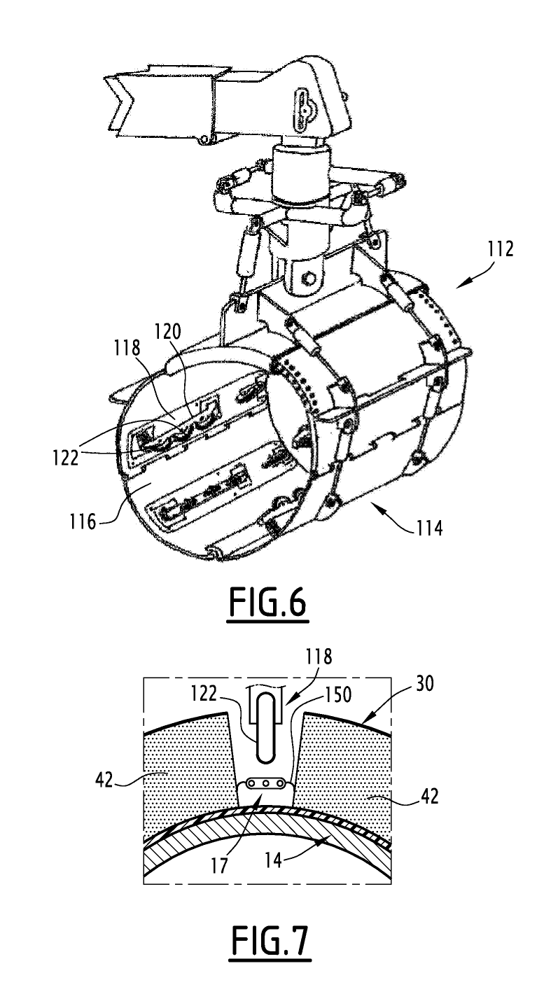

FIG. 6 is a perspective view of an assembly for guiding at least one electric line intended to be placed in the longitudinal groove of the sleeve of the pipe;

FIG. 7 is a partial schematic view of the guiding assembly and of the pipe upon introducing the electric line into a groove;

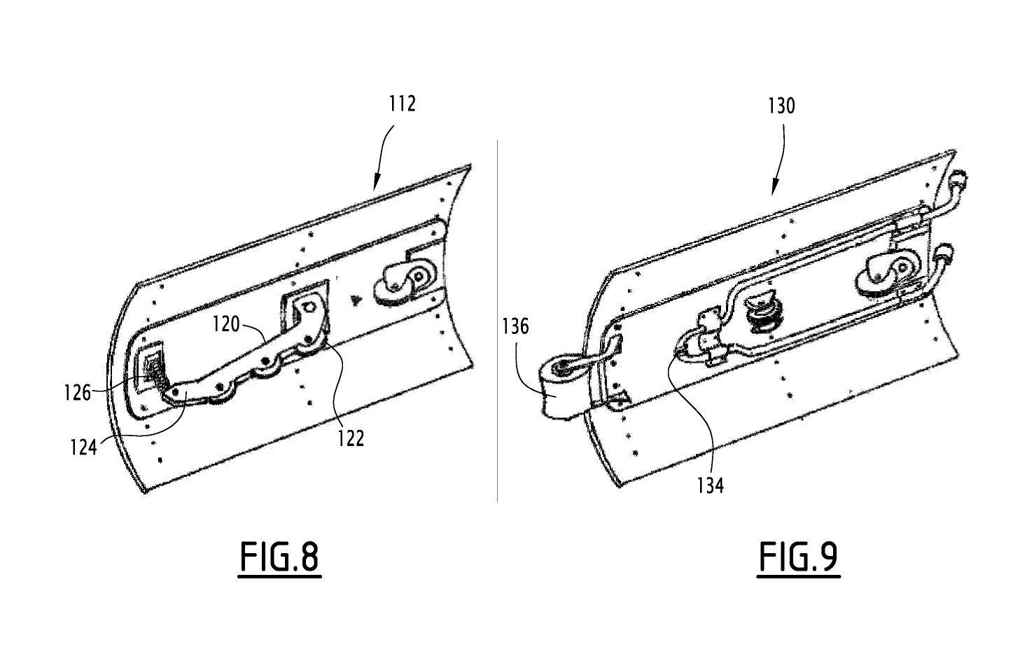

FIG. 8 is a view of a detail of the guiding assembly of FIG. 6;

FIG. 9 is a perspective view of an assembly for injecting a fluid material in a longitudinal groove made in a sleeve of the pipe;

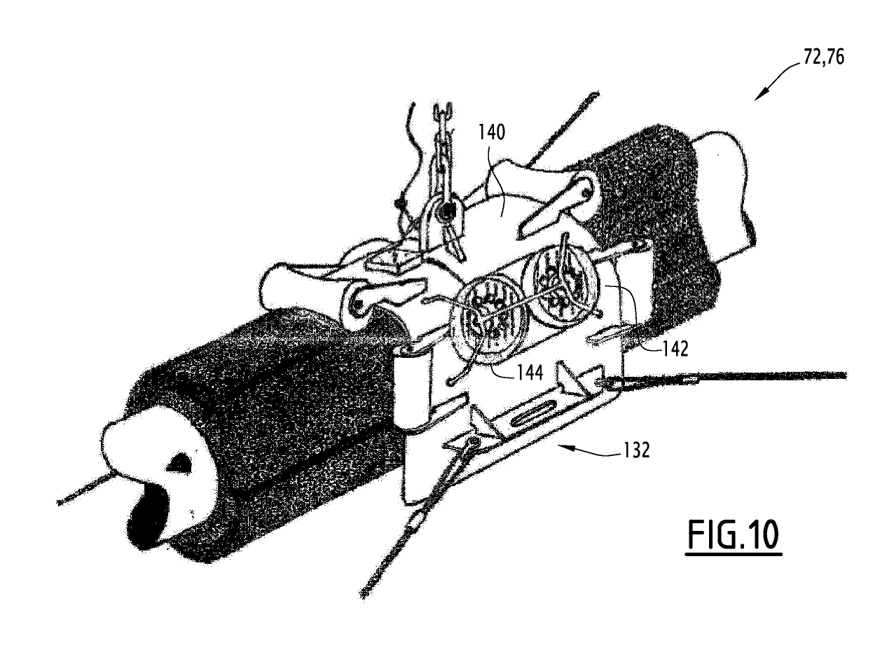

FIG. 10 is a perspective view of an assembly for solidifying the fluid material injected into the groove;

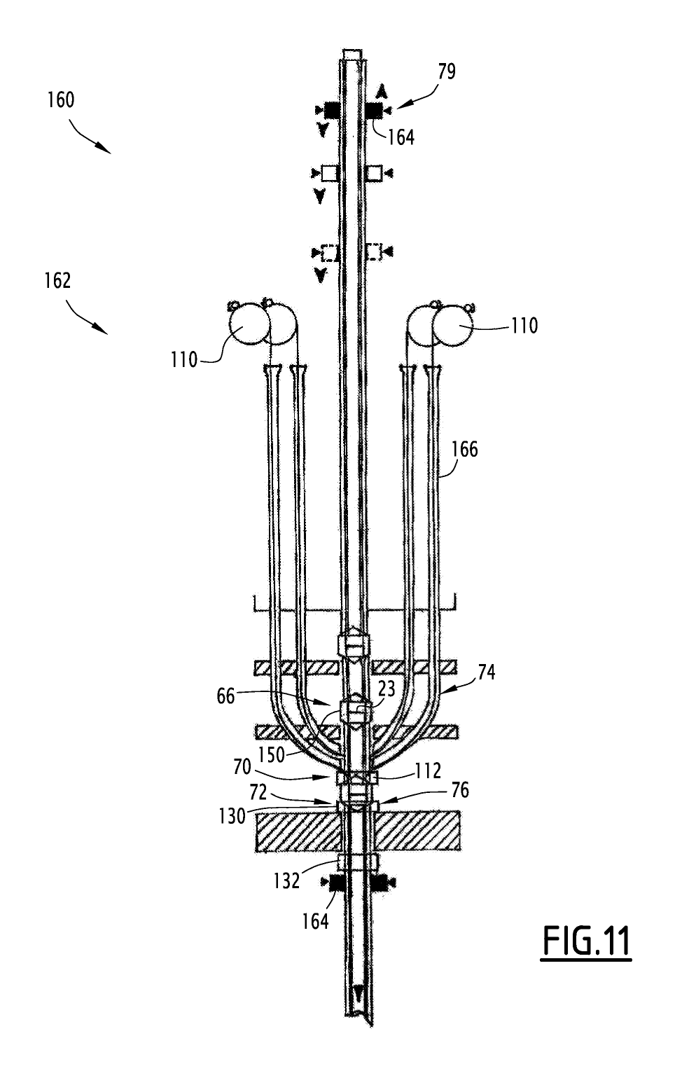

FIG. 11 is a schematic side view of a second installation for assembling the pipe of FIG. 1, for a J laying method;

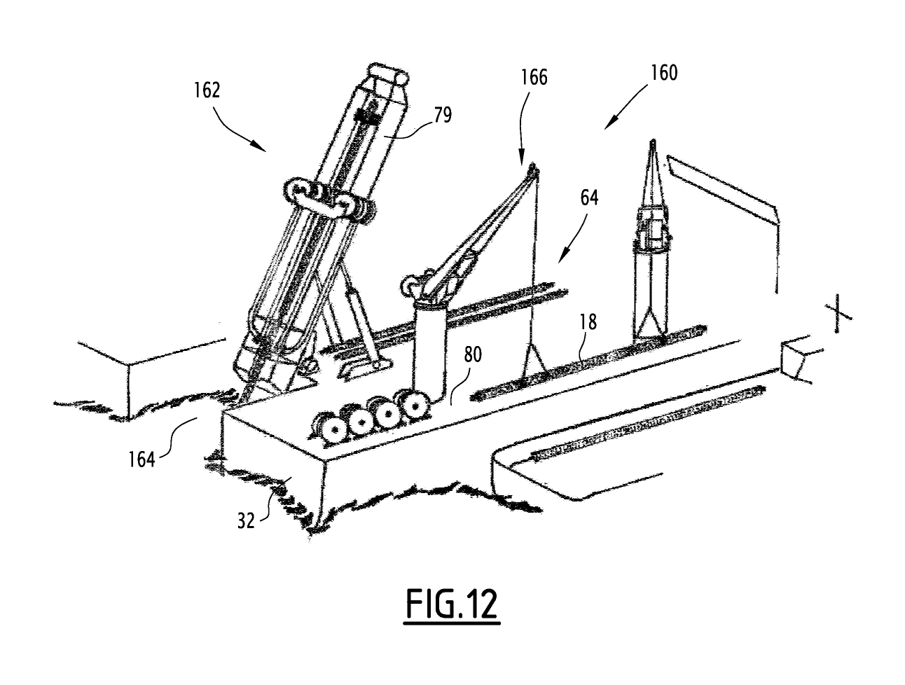

FIG. 12 is a partial perspective view of the installation of FIG. 11.

In the meaning of the present invention, an element is generally “metal” when more than 50% by mass of this element is formed with metal. It is generally “non-metal” when 50% or less by mass of this element is formed with metal.

A first rigid pipe 10 for conveying a fluid manufactured by an assembling method according to the invention is illustrated by FIGS. 1 and 2.

The rigid pipe 10 is intended to be immersed in a stretch of water 12 for transporting a fluid through the stretch of water 12.

The rigid pipe 10 is for example laid on the bottom of the stretch of water 12 in order to connect a fluid connection installation, such as a well, to an assembly for conveying fluid towards the surface. Alternatively, the rigid pipe 10 extends through the stretch of water 12, from the bottom of the stretch of water 12 towards the surface.

The stretch of water 12 is for example a sea, an ocean, a lake or a river. The depth of the stretch of water 12 is generally greater than 10 m, and for example is comprised between 100 m and 5,000 m.

The sampled fluid conveyed by the rigid pipe 10 is notably a hydrocarbon, such as petroleum or natural gas.

As illustrated by FIGS. 1 and 2, the rigid pipe 10 includes a central metal tube 14 and a non-metal thermally insulating casing 16 positioned around the central metal tube 14. The thermally insulating casing 16 is intended to come into contact with the stretch of water 12 in which is immersed the pipe 10.

The rigid pipe 10 further includes at least one functional line 17, here a heating line, positioned on the outside of the central metal tube 14 in the thermally insulating casing 16.

The central tube 14 includes an end-to-end assembly of tube sections 18. It delimits a continuous central passage 20 for circulation of the fluid through several tube sections 18, between the ends of the pipe 10.

The central tube 14 for example has an outer diameter comprised between 10 cm and 130 cm. The outer diameter of the central passage 20 is for example comprised between 8 cm and 127 cm.

Each tube section 18 is made on the basis of metal, for example in steel, in stainless steel and in other steels with variable nickel content or a combination of these materials (example: steel tubes interiorly coated with stainless steel).

Each tube section 18 has a length advantageously comprised between 12 m and 96 m.

The section 18 is advantageously provided on the outside with a protective layer 22, such as an epoxy layer bound by melting.

The ends of each pair of adjacent tube sections 18 are attached together at a junction 23 in order to form a continuous tube 14. This attachment is for example achieved by welding.

The thermally insulating casing 16 includes a continuous inner layer 24, intended for thermal insulation, and optionally an outer protective layer 26 surrounding the inner layer 24.

According to the invention, the inner layer 24 includes, for each tube section 18, a thermally insulating sleeve 30 delimiting at least one longitudinal groove 32 for inserting a heating line 17.

In this example, the inner layer 24 further includes for each longitudinal groove 32, a plug 34 for outer obturation of the groove 32. The inner layer 24 further includes, between each pair of adjacent sleeves 30, a thermally insulating connection 36 of the junction 23 between the adjacent tube sections 18.

Each thermally insulating sleeve 30 is attached on the outer surface of a tube section 18, on the protective layer 22, when the section 18 is provided with such a layer 22.

The sleeve 30 is for example formed on the basis of a thermally insulating material, notably based on a foam of a polymer, such as a polyolefin (PP, PE) or a polyurethane (PU).

The heat conductivity of the thermally insulating material is for example less than 0.4 W/(m.K)

The maximum thickness of the sleeve 30 is preferably greater than the thickness of the section 18. This thickness is for example comprised between 30 mm and 150 mm.

The thermally insulating material forming the sleeve 30 is able to be impregnated with water when the pipe 10 is immersed in the stretch of water 12.

In the example illustrated in FIG. 1, the length of the sleeve 30, taken along the axis of the pipe 10, is less than the thickness of the tube section 18 on which the sleeve 30 is attached.

The sleeve 30 thus delimits, on the tube section 18, a central portion 38 at least partly covered by the sleeve 30, and two end portions 40 protruding beyond the sleeve 30 for facilitating the assembling of the tube section 18 with an adjacent tube section 18.

Each sleeve 30 delimits at least one longitudinal groove 32. Advantageously, each sleeve 30 defines a plurality of longitudinal grooves 32 angularly distributed around the axis of the pipe 10.

The number of longitudinal grooves 32 is for example comprised between 1 and 12 according to the dimensioning of the pipe.

In the example illustrated in FIGS. 1 and 2, each longitudinal groove 32 extends linearly parallel to the axis of the pipe 10. Alternatively, (not shown), each longitudinal groove 32 extends in a curved way with respect to the axis of the pipe 10, for example helically.

Each longitudinal groove 32 has an angular extent less than the angular extent of the side portions 42 of the sleeve 30 which laterally delimit the groove 32.

In the example illustrated in FIG. 2, each longitudinal groove 32 has a cross-section which is flared from the inside of the pipe 10 towards the outside of the pipe 10.

The groove 32 entirely crosses the sleeve 30. It radially opens into the inside facing the tube section 18 which delimits its bottom. It radially opens towards the outside facing the outer layer 26.

Further, the groove 32 axially opens at its longitudinal ends at right angles to an end portion 40 of the tube section 18.

Each groove 32 is radially obturated outwards by a plug 34 fixed in the groove 32.

In the example illustrated in FIGS. 1 and 2, the plug 34 is formed by a self-supporting longitudinal part in a thermally insulating material. The plug 34 is then added in the groove 32 and fixed in the latter via attachment means 44.

Alternatively, the plug 34 is formed by injecting a fluid material having hardened in the groove 32.

The plug 34 has dimensions mating that of the groove 32. It is outwardly flush with the side portions 42 of the sleeve 30.

The attachment means 44 comprise here at least one snap-on protrusion 46, secured to one of the plugs 34 and of a side portion 42, the protrusion 46 being received in a mating housing 48 made in the other of the plug 34 and of the side portion 42.

The connection 36 (visible in pointed lines in FIG. 1) covers the assembled end portions 40 of each pair of adjacent tube sections 18 at the junction 23.

It longitudinally connects the respective insulation sleeves 30 of the adjacent tube sections 18, in order to ensure the continuity of the inner layer 24. Thus, no cold point is present on the length of the pipe 10.

The outer surface of the connection 36 is substantially flush with the outer surface of the sleeves 30 which it connects.

The connection 36 consists of a thermally insulating material. For example it is formed by injecting a fluid material facing the end portions 40 and then by hardening this material.

The outer layer 26 for example comprises a winding of a protective strip 50 around the inner layer 24.

The thickness of the outer layer 26 is less than, notably less than at least twice the thickness of the inner layer 24.

No metal tube is present in the thermally insulating casing 16, which considerably lightens the weight of the pipe 10.

The outer layer 26 defines an outer surface of the pipe 10 in contact with the stretch of water.

Each groove 32 advantageously receives at least one functional line 17.

The functional line 17 is for example an electric line able to achieve electric heating tracing on the central tube 14, outside the central tube 14. It is placed in thermal contact with the outer surface of the central tube 14, either by being directly laid against the metal surface of a tube section 18, or by being laid on the protective layer 22 when this layer 22 is present.

The functional line 17 is for example made by a cord of cables or conducting wires received in a metal sheath.

In the example illustrated in FIGS. 1 and 2, it has an elongated cross-section with a width greater than its thickness.

The functional line 17 is positioned in a groove 32. It is placed at the bottom of the groove 32, between the outer surface of a tube section 18 and the plug 34 obturating the groove 32.

The functional line 17 continuously extends along the pipe 10, in the grooves 32 of at least two adjacent tube sections 18, advantageously in the grooves 32 of at least 50% of the tube sections 18 of the pipe 10.

The line 17 also continuously extends facing each junction 23 between two adjacent tube sections 18 on the end portions 40 of the sections 18, and under the connection 36.

The line 17 thus has a length greater than that of a section 18, advantageously greater than that of at least two sections 18. Therefore it is not necessary to provide electric connectors on the line 17 between each pair of adjacent sections 18 at the junction 23.

In a first embodiment, the pipe 10 is assembled in a first installation 60 according to the invention, illustrated by FIGS. 3 to 10.

The first installation 60 according to the invention is intended to carry out S-laying of the pipe 10.

The installation 60 includes a supporting structure 62, a station 64 for storing and providing tube sections 18, and a station 66 for end-to-end assembling tube sections 18.

In this example, the tube sections 18 present in the storage station 64 are provided with a sleeve 30 without any grooves 32. The installation 60 then includes a station 68 for producing the grooves 32.

It also comprises a station 70 for introducing and guiding each functional line 17 in a groove 32 and a station 72 for filling in the grooves 32.

The installation 60 advantageously includes a station 74 for coating the junction 23 between each pair of adjacent tube sections 18, and a station 76 for manufacturing the connection 36 on the junction 23.

The installation 60 downstream includes a station 78 for moving down into the stretch of water 12.

The installation 60 further includes an assembly 79 for displacing the assembly of tube sections 18 between the stations 64 to 78, for example comprising tracked tensioners.

In this example, the supporting structure 62 is floating on the stretch of water 12. For example it is formed by a barge having a deck 80 bearing the stations 64 to 78.

The storage and provision station 64 includes a surface for storing individual tube sections 18, and means for conveying each tube section 18 towards the assembling station 66.

The assembling station 66 includes means for successive alignment of the various tube sections 18 in a substantially horizontal plane and attachment means, advantageously by welding, for the ends facing each pair of adjacent tube sections 18.

As illustrated by FIG. 5, the station 68 for producing the grooves 32 includes a yoke 90 for supporting and guiding the sleeve 30 of the tube section 18, and for each groove 32 to be produced, a longitudinal cutting member 92 of the sleeve 30 and an assembly 94 for sucking up the material cut out by the member 92.

Each longitudinal cutting member 92 includes here a rotary blade 96 and a mechanism for driving into rotation (not shown) the blade 96.

The longitudinal cutting member 92 is able to penetrate the thickness of the sleeve 30 for mating the groove 32.

The suction assembly 94 includes a cup 98 for collecting solid residues removed by the blade 96, positioned around the longitudinal cutting member 92 and a pipe 100 for discharging the solid residues, connected to a suction source (not shown).

With reference to FIGS. 4, 6 and 8, the introduction station 70 includes, for each line 17, a spool 110 for storing and unwinding the line 17. The station 70 further includes an assembly 112 for guiding each unwound line 17 from a spool 110 in the groove 32.

The length of the line 17 present on the spool 110 is for example greater than 100 m, notably comprised between 200 m and 20 km.

In the example of FIG. 6, the guiding assembly 112 includes a sleeve 114 delimiting an inner lumen 116 for circulation of the assembled tube sections 18 and, for each groove 32, a member 118 for pushing the line 17 into the groove 32.

The pushing member 118 radially protrudes in the lumen 116 from the sleeve 114. In the example illustrated in FIGS. 6 and 8, the pushing member 118 includes a jointed finger 120 on the sleeve 114 by a first end.

The finger 120 bears at least one roller 122 intended to come into contact with the line 17. It has a free end 124 radially urged towards the axis of the lumen 116 by an elastic urging member 126.

With reference to FIGS. 3 and 9, the filling-in station 72 includes an assembly 130 for injecting fluid material into each groove 32, and an assembly 132 for hardening the solid material in order to form a plug 34.

In the example illustrated in FIG. 9, the injection assembly 130 includes for each groove 32, a nozzle 134 for injecting the fluid material into the groove 32 and a member 136 for distributing the fluid material in the groove 32. The member 136 is for example formed by a roller.

As illustrated by FIG. 10, the hardening assembly 132 includes a saddle 140 intended to straddle each tube section 18 provided with a sleeve 30, and for each groove 32, at least one heating member 142, able to accelerate hardening of the fluid material introduced into the groove. Advantageously, the assembly 132 further includes a member 144 for cooling the material contained in the groove 32 in order to obtain a solid plug 34.

The station 74 includes an assembly 140 for cleaning the junction between each pair of sections 18, for example by projection of a powdery material, and an assembly 142 for depositing a coating on the junction.

In the example illustrated in FIG. 3, the cleaning assembly 140 is positioned upstream from the station 68 for producing the grooves 32 and the deposition assembly 142 is positioned downstream from the station 68, upstream from the introduction station 70.

The station 76 for making the connection 36 is here positioned between the introduction station 70 for each line 17 in a groove 32 and the station 72 for filling in each groove 32.

With reference to FIG. 3, it includes an assembly 144 for supplying a fluid material intended to form the connection 36 on the junction 23 and an assembly for hardening the fluid material formed here by the same assembly 132 as the one of the filling-in station 72.

The downward movement station 78 includes a tilted ramp 150 able to lead the pipe 10 out of the floating structure 62 according to a slightly tilted axis with respect to the horizontal (S laying). This adjustable downward movement station is generally called a “Stinger”.

A first method for assembling a rigid pipe 10 according to the invention, applied by means of the installation 60, will now be described.

The pipe 10 is sequentially assembled, by adding to each already assembled tube section 18, a new tube section 18.

Initially, disconnected tube sections 18, each provided with an insulation sleeve 30 without any introduction groove 32 are provided on the storage surface of the station 64. Next, a first tube section 18 is placed in the assembling station 66.

In a first step of the method, an end of a second tube section 18 is placed facing the free end of the first tube section 18 assembled in the station 66.

And then, a junction 23 is made between these two tube sections 18, for example by welding together the end portions 40.

Subsequently, the thereby made assembly is displaced downstream by adding a new tube section 18 in the assembling station 66. The junction 32 between the first and the second tube section 18 then passes facing the cleaning assembly 140 of the coating station 74 so as to be cleaned therein, for example by projection of a powdery material.

During a new displacement of the assembly downstream, the sleeve 30 of the first tube section 18 enters the station 68 for producing the grooves 32.

As illustrated by FIG. 5, the longitudinal cutting members 92 penetrate the sleeve 30 and remove material from the sleeve 30 so as to make each groove 32. The thereby removed material is discharged by the suction means 94 through the flange 98 and the discharge pipe 100.

The junction 23 then arrives at the coating assembly 142 for receiving the protective layer 22.

Upon a new displacement of the assembly, the sleeve 30 of the first tube section 18 attains the introduction station 70.

During this displacement, each line 17 is unwound from a spool 110 and introduced into a groove 32 upon its passage in the guiding assembly 112.

In the embodiment of FIGS. 6 to 8, each line 17 cooperates with a pushing member 118, causing flattening of the line 17 against the bottom of the groove 32.

Each line 17 is continuously unwound over the whole of the length of the successive sections 18, and on each junction 23 between two sections 18, without it being necessary to make a connection of two line sections at the junction 23.

During a new displacement of the assembly downstream, the junction 23 through which passes each line 17, attains the station 76 for making the connection 36.

The supply assembly 154 fills the intermediate space between two sleeves 30 at the junction 23 with a fluid material intended to harden so as to form the connection 36 covering the junction 23.

Upon a new displacement of the assembly downstream, the sleeve 30 passes in front of the filling-in station 72.

The injection assembly 130 then fills each groove 32 with a fluid material able to solidify so as to form a plug 34.

Advantageously, as illustrated by FIG. 9, the fluid material is injected via the nozzle 134, and is then distributed via the member 136.

Subsequently, upon a new displacement of the assembly downstream, each groove 32 filled with fluid material, and then the junction 23 pass into the hardening assembly 132.

In the embodiment of FIG. 10, the fluid material is heated by the heating member 142 in order to accelerate its hardening, and is then cooled by the cooling member 144 facing the saddle 140. A solid plug 34 is thus formed in each groove 32 in order to obturate the groove 32 outwards and to maintain in position the line 17 contained in the groove 32.

Also, the fluid material covering the junction 23 solidifies in order to form the connection 36 and ensure continuity of the inner layer 24.

Next, in a step (not shown), the outer layer 26 is applied over the inner layer 24.

And then, upon a new displacement of the assembly downstream, the assembled tube sections 18 pass over the ramp 150 and are gradually moved down into the stretch of water 12 by adopting an S configuration.

The method according to the invention is therefore particularly simple to carry out. It gives the possibility of depositing a continuous line 17 on a central tube 14 formed with an assembly of tube sections 18, just downstream from the assembly of tube sections 18, without having to produce connections on the line 17. The assembling is therefore substantially carried out at the same speed as a conventional assembling of a rigid pipe without any lines 17.

Further, the pipe 10 according to the invention is without any outer metal tube surrounding the thermal insulating casing 16. This pipe is therefore particularly lightweight, while retaining the adequate properties for warming up the fluid.

In an alternative, the functional line 17 is a hydraulic line, an optical line, or further a combination of an electric and/or hydraulic and/or optical line.

In further another alternative, at least one groove 32 contains a plurality of lines 17, positioned side by side or one over the other.

In another alternative, visible in FIG. 8, the line 17 is provided with blocking members 150 in the groove 32, able to cooperate with the side walls delimiting the groove 32 for blocking in position the line 17 in the groove 32 before setting into place the plug 34.

In another alternative, the disconnected tube sections 18 provided on the structure 62 in the storage station 64 comprise sleeves 30 defining at least one introduction groove 32, before assembling the tube sections 18. In this case, the installation 60 is without any station 68 for producing the grooves 32.

During the assembling step, the pre-existing grooves 32 on the sleeves 30 of each pair of adjacent tube sections 18 are placed facing each other angularly during the assembling of the pair of tube sections 18.

In further another alternative, the plugs 64 are pre-formed. They are made by self-supporting blocks of a thermally insulating material. The filling-in station 72 then includes an assembly for setting into place the plugs 64 in the grooves 32.

A second laying installation 160 according to the invention is illustrated by FIGS. 10 and 11. This installation 160 is intended for laying a pipe 10 as a J.

Unlike the installation 60 illustrated in FIGS. 1 to 9, the installation 160 includes a mounting tower 162 placed at right angles to a well 164 made in the structure 62, or at right angles to an edge of the structure 62. The assembly 79 for displacing the assembly of tube sections 18 in this example includes two pairs of stepping clamps 164, able to grasp a tube section 18 and to displace it in translation along the axis of the tower 162. The displacement assembly 79 is here borne by the tower 162.

The displacement assembly 79 gives the possibility of moving down the pipe 10 into the stretch of water 12 substantially vertically.

In the example illustrated in FIG. 11, the tower 162 is without any station 68 for making the grooves 32. The disconnected tube sections 18 present in the storage and provision stations 64 have insulation sleeves 30 provided with grooves 32.

As illustrated by FIG. 11, the tower 162 bears the assembling station 66, the introduction station 70, the filling-in station 72 and the station 76 for making the connection. The tower 162 also bears the coating station 74, when it is present.

Preferably, the spools 110 of the introduction station are positioned laterally on the tower 162, above the assembling station 66 and above the guiding assembly 112. Supply chutes 166 are provided for guiding each line 17 unwound from a spool 110 towards the guiding assembly 112.

During the application of the assembling method, for each new tube 18 to be assembled, the conveying means 166 grasp the tube section 18 and bring it onto the tower 162, by placing it in the axis of the tower 162.

Next, the tube section 18 is grasped by an upper clamp 164, with its lower end placed in the assembling station 66 so as to be fixed therein on the free end of another tube section 18.

Subsequently, the clamp 164 moves the tube section 18 down into a first intermediate position allowing the cleaning of the junction 23 by the cleaning assembly 150.

The tube section 18 is then moved down in order to pass through the guiding assembly 112 of the introduction station 70, where the grooves 32 receive the lines 17 unwound from the spools 110.

In a second intermediate position of the clamp 164, the junction 32 is located facing the station 76 for making the connection 36 in order to receive the fluid material able to solidify.

And then, the tube section 18 again moves down in order to have the grooves 32 of the sleeve 30 pass into the injection assembly 130, and then, into the hardening assembly 132, in order to form each plug 34.

The thereby produced pipe 10 is then vertically immersed into the stretch of water 12 in order to achieve the J-shape laying.

In an alternative (not shown) of the first method according to the invention, the central tube 14 is manufactured on land, by providing it with sleeves 30 defining introduction grooves 32. The central tube 14 is then wound on a drum or in a basket, before being loaded on the structure 62.

When the pipe 10 has to be laid, the central tube 14 is unwound so as to successively pass into an introduction station 70, into a filling-in station 72, and then into a station for making the connection 76, as described earlier for the first method.

When the plug 34 is formed by a self-supporting part or by injection of a fluid material, the material forming the plug 34 is for example a thermosetting material.

Alternatively, the plug 34 is formed by a part in thermoplastic material, notably in an olefinic thermoplastic material, in particular in polyethylene or in polypropylene.

In an advantageous example, the thermal insulating sleeve 30 is formed in a thermoplastic material while being initially without any grooves 32.

The grooves 32 are made by means of a cutting tool by heating the thermoplastic material of the sleeve 30. The cutting out is carried out in a clean way, in order to make up, from each made groove 32, a self-supporting solid part with dimensions mating those of the groove.

Once the continuous functional line 17 is introduced into the groove 32, the self-supporting part is reintroduced into the groove 32 and is again adhesively bonded by heating, thereby forming a plug 34. Thus, the loss of material is zero, since the plug 34 is exclusively formed with the material cut out in the sleeve 30, which is reused.

For applying this alternative, the material cut out from the sleeve 30 is moved radially away from the sleeve 30 for letting through the flexible line 17 with view to its introduction into the groove 32, and then is continuously brought closer and without any cutting towards the sleeve 30 for again filling in the groove 32.

A heating crown is then passed around the sleeve 30 in order to achieve adhesive bonding of the plug 34. The crown advantageously includes a tool for radially cutting the plug in order to cut out the excess of radial material of the plug 34 due to the presence of the line 17 in the groove 32.

1. A method for assembling a rigid pipe configured to be placed in a stretch of water, the rigid pipe comprising a metal inner tube, and a non-metal thermally insulating outer casing intended to be placed in contact with the stretch of water,
the method comprising the following steps:
assembling metal tube sections end-to-end in order to foil an inner tube having a continuous passage for circulation of fluid;
positioning a thermally insulating sleeve around each metal tube section, the thermally insulating sleeve comprising at least one longitudinal groove;
introducing a continuous functional line into at least two longitudinal grooves of at least two adjacent tube sections;
filling in each longitudinal groove in order to cover the continuous functional line.

2. The method according to claim 1, wherein the filling in of each longitudinal groove comprises the setting into place of a self-supporting part of a thermally insulating material in the longitudinal groove.

3. The method according to claim 1, wherein the filling in of each longitudinal groove comprises the filling of each longitudinal groove with a fluid material and the hardening of the fluid material in order to form a plug of thermally insulating material.

4. The method according to claim 1, wherein each metal tube section includes an end portion longitudinally protruding beyond the thermally insulating sleeve, the step for forming the continuous outer casing comprising, after end-to-end assembling of two adjacent tube sections, the formation of a thermally insulating connection covering the end portions, the insulation connection connecting the thermally insulating sleeves of both adjacent tube sections.

5. The method according to claim 1, wherein said or each longitudinal groove is pre-formed during the manufacturing of the thermally insulating sleeve.

6. The method according to claim 1, including a step for making at least one longitudinal groove in the thermally insulating sleeve by removal of material.

7. The method according to claim 6, wherein the material removed for making the longitudinal groove is used for forming at least partly the plug.

8. The method according to claim 1, wherein the plug is formed on the basis of a thermosetting material, or on the basis of a thermoplastic material.

9. The method according to claim 1, wherein the introduction step includes the flattening of the continuous functional line against a bottom of the longitudinal groove via a guiding assembly.

10. The method according to claim 1, wherein the introduction step includes the unwinding of a spool bearing the continuous line, in order to bring the continuous line into a longitudinal groove.

11. The method according to claim 1, including a step for laying as an S- or J-assembled metal tube sections in the stretch of water, after the step for forming the outer casing.

12. An installation for assembling a rigid pipe configured to be placed in a stretch of water, the rigid pipe comprising a metal inner tube, and a non-metal thermally insulating outer casing intended to be placed in contact with a stretch of water, the installation comprising:
a station for assembling metal tube sections end-to-end in order to form an inner tube having a continuous passage for circulation of fluid;
an assembly for providing a plurality of tube sections provided with a thermally insulating sleeve, the thermally insulating sleeve comprising at least one longitudinal groove substantially extending as far as the metal tube;
a station for introducing a continuous functional line into at least two longitudinal grooves of at least two adjacent tube sections;
a station for filling in each longitudinal groove in order to cover the continuous functional line.

13. The installation according to claim 12, comprising a floating structure bearing the assembling station, the supply assembly, the introduction station, and the filling-in station.

14. A rigid pipe intended to be placed in a stretch of water, comprising:
a metal inner tube, and
a non-metal thermally insulating outer casing intended to be placed in contact with the stretch of water, the inner tube comprising an end-to-end assembly of metal tube sections, the inner tube delimiting a continuous passage for circulation of fluid;
the outer casing continuously extending around the assembled metal tube sections;
the outer casing comprising a thermally insulating sleeve positioned around each metal tube section, the thermally insulating sleeve comprising at least one longitudinal groove substantially extending as far as the inner tube;
the pipe including a continuous functional line introduced at least into two longitudinal grooves of at least two adjacent tube sections;
the outer casing comprising a plug obturating each longitudinal groove in order to cover the continuous functional line.

15. The pipe according to claim 14, wherein the plug is formed from a fluid material having hardened in the longitudinal groove.

16. The pipe according to claim 14, wherein the plug is formed from a self-supporting part added into the longitudinal groove.

17. The pipe according to claim 14, wherein the continuous functional line is selected from an electric heating cable, a hydraulic heating line, an electric and/or optical and/or hydraulic cable.
